(19) United States
(12) Patent Application Publication
(10) Pub. No.: US 2016/0299896 A1
(43) Pub. Date: Oct. 13, 2016

(54) PROCESSING A SEARCH QUERY AND RANKING RESULTS FROM A DATABASE SYSTEM OF AN ELECTRONIC MESSAGING SYSTEM

(71) Applicants: VINAY BAWRI, Kolkata (IN); MALVIKA BAWRI, Kolkata (IN); RITESH BAWRI, Kolkata (IN)

(72) Inventors: VINAY BAWRI, Kolkata (IN); MALVIKA BAWRI, Kolkata (IN); RITESH BAWRI, Kolkata (IN)

(21) Appl. No.: 15/093,437

(22) Filed: Apr. 7, 2016

(30) Foreign Application Priority Data
Apr. 8, 2015 (IN) 1022/KOL/2014

(51) Int. Cl. G06F 17/30; H04L 12/58

(52) U.S. Cl. CPC G06F 17/3053; G06F 17/30557; G06F 17/30598; H04L 51/046

(57) ABSTRACT

Systems and methods are disclosed for processing a search query with respect to one or more database systems on a local computing system or a remote networked computing system. The search query may be parsed to identify a search context. The database systems may include electronic messages and the associated digital data attachments. The results retrieved from the database system based on the search query processing may be ranked. The ranking can correspond to the extent of relevancy of the search query. The retrieved results can be sorted according to the rankings. The sorted results can be outputted on a computing device.

### CROSS REFERENCE TO RELATED APPLICATIONS

This complete specification is filed in pursuance of the provisional Indian patent application numbered 1022/KOL/2014 filed at Indian Patent Office on 8^{th} Apr. 2015.

### FIELD OF THE DISCLOSURE

The present disclosure relates to the field of processing a search query, retrieving results from a database system or a data structure, and ranking the retrieved digital data.

### BACKGROUND OF THE DISCLOSURE

Searching for digital files or data of any type on a network system, such as the web or in data repositories has been a field of constant development. More often than not, a user specially uses searching interface of email clients, for example Microsoft Outlook™, IBM Lotus Notes™ and the like, to retrieve the relevant digital files. In addition to the email clients, the search option is often used by a user in offline systems such as intranets, corporate data repositories, desktops e.g. a user searches a presentation on a desktop.

When a user searches for digital files on data repositories, email clients, desktops and the like, the user is usually presented with many digital files as search results. These search results often contain a combination of relevant and irrelevant digital files based on the user's search query. Accordingly, a majority of such irrelevant digital files retrieved in the search results are not of any relevance to the user.

Accordingly, a lot of times the user is required to go through many of all the digital files that the search result displays in order to locate the digital file that the user is actually searching for. This is a tedious process as it takes up the user's time and requires considerable intervention on the part of the user.

There are some searching interfaces which try to solve the problem of retrieving digital files as per the user's input. These interfaces are adapted to retrieve digital files from data repositories. However, it is found that these existing searching interfaces are not intelligent enough to understand the user's search query/requirement well enough. The algorithms used currently usually fail to intelligently find and present the specific digital files that the user is looking for. Usually, the content in the digital files is ‘blindly’ matched with the user's search query and the digital files are simply displayed to the user in chronological order.

To tackle the above mentioned problems advancement is required in searching and ranking modules. A few inventions have been developed that introduce different platforms for searching and ranking. One such invention is described in US granted U.S. Pat. No. 8,745,045 (hereinafter referred as '045) by the inventors of the present patent application, incorporated by reference in its entirety. The '045 patent discloses various techniques of searching and ranking electronic mails. As per '045 patent, the searching is designed to be contextual in nature in synchronization with the search term that the user inputs. Further, the '045 patent, discloses various ranking modules useful for ranking emails, digital files and/or attachments based on various algorithms.

### SUMMARY

There is a need to develop methods and systems to search and rank digital files in data repositories, email clients, intranets, corporate data repositories, desktops and cloud storage etc. Further, there is a need for such methods and systems which can intelligently and quickly understand and identify context corresponding to the user's search term, and intelligently retrieve and rank digital files using advanced computing methods. Furthermore, there is a need for such methods and systems, which use advanced hierarchy criteria and algorithms for ranking digital files available in various data repositories, email clients, intranets, corporate data repositories, desktops and cloud storage. There is a constant need to enable the user to retrieve relevant digital files as per their requirements, thereby reducing the user's time in screening and locating the digital files they are searching for.

Therefore, an object of the present disclosure is to develop techniques and modules for intelligent and easy searching and ranking of digital files in data repositories, email clients, intranets, desktops and cloud storage etc.

Yet another object of the present disclosure is to provide advanced computing methods having improved and advanced hierarchy criteria and algorithms which enables ranking of digital files available in various data repositories, email clients, intranets, desktops and cloud storage etc.

Another objective of the present disclosure is to develop systems and methods which reduce the user's time in screening and locating the relevant digital files.

Yet another object of the present disclosure is to provide methods and systems which may intelligently identify context corresponding to the user's input search terms, and intelligently retrieve, filter, rank and display digital files.

Yet another object of the present disclosure is to provide methods and systems for efficiently searching and retrieving the digital files.

Yet another object of the present disclosure is to provide an intelligent sorting process corresponding to the degree of ranking.

Yet another object is to find relevant information which is structured and then presented to the user in order to serve as a knowledge bank.

These and other objects and advantages of the invention will be clear from the ensuing description.

Systems and methods for searching, filtering and ranking digital files in data repositories, email clients, intranets, desktops, cloud storage etc. is disclosed.

The present disclosure provides solutions to the problems by presenting methods and systems for searching and ranking digital files on data repositories, such as the user's desktop, desktop and web services like Dropbox, cloud computing systems, servers and the like. The method and system includes receiving one or more search terms from the user. Further, the method and system includes identifying a search context corresponding to the user's search term(s). Moreover, the search context is identified on the basis of a pre-defined syntax and algorithm instead of the present prevalent method of displaying the results only by ‘blind matching’ in descending order of date.

In an aspect, the one or more search term input by the user is a text, or multimedia such as an audio, video, image, graphics interchange format (GIF) etc., or a braille input, or a combination thereof.

After identifying the search context, the present method and system searches the relevant digital files as present in various data repositories. Further, the present method and system includes ranking of the said searched digital files. Thereafter, the ranked digital files get sorted based on predefined criteria. Digital files that are ranked higher are considered more relevant to the users search query and are thus placed at a higher position during sorting.

The method and system then displays the sorted digital files based on their degree of ranking with regard to the user's search query. These digital files are displayed/presented to the user either as the digital file itself, as a name of the digital file, as a link to the digital file, as an image of the digital file, as an audio or video file (when applicable) and/or only the relevant portions of the digital file. Further, these digital files are also displayed/presented to the user using a combination of the criteria above.

These aspects of the present invention, along with the various features of novelty that characterize the present invention, are pointed in the below description. For a better understanding of the present invention, its operating advantages, and the specific objects attained by its uses, reference should be made to the accompanying drawing and descriptive matter in which there is illustrated an exemplary embodiment of the present invention.

### DESCRIPTION OF THE DRAWINGS

The advantages and features of the present invention will become better understood with reference to the following detailed description taken in conjunction with the accompanying drawings.

FIG. 1 illustrates a block diagram of a system 100 according to an embodiment of the present disclosure;

FIG. 2 illustrates a flow diagram for database query processing according to an embodiment of the present disclosure;

FIG. 2A illustrates various criteria to determine context of a search term according to an embodiment of the present disclosure;

FIGS. 3 and 3(a) illustrate different hierarchy examples according to an embodiment of the present disclosure; and

FIGS. 4-5 illustrate a process implemented by a computing system for ranking digital files according to an embodiment of the present disclosure.

Like reference numerals refer to like parts throughout the description of several views of the drawing.

### DESCRIPTION OF THE INVENTION

The exemplary embodiments described herein detail for illustrative purposes are subject to many variations in implementation. It should be emphasized, however, that the present invention is not limited to a method and system for searching and ranking digital files in data repositories. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

Unless otherwise stated, the term “attachment” refers to a computer file or data structure for storing information. Few examples include but are not limited to, word, excel, pdf, audio file, video file, GIF, setup file, data files, system file, .exe file and the like. The term “file” or “digital file” is also interchangeably used with “attachment”.

The present invention provides systems and methods for searching and ranking digital files in data repositories. The term “data repositories” as mentioned herein refers to logical and sometimes physical aggregation of data where multiple databases which apply to specific applications or sets of applications reside. Data repository is either a virtual or physical storage space for digital data. The storage space is both online and offline. Suitable examples of data repositories include, but are not limited to, online repositories like Dropbox, cloud repositories, or local data repositories on a user's computing devices, and the like. Hence, the term “Data repository” is referred to any of the above mentioned storage spaces and unless otherwise stated, should not be construed as storage of one particular kind.

The present invention is also equally applicable to various data repositories on the World Wide Web, and the like. The term data repositories is not limited to a depository on the web but also includes storage spaces like hard disks, pen drives, external hard drives or any other memory element where data can be stored.

It will be apparent to a person skilled in the art that the present searching capabilities of conventional digital file searching interfaces are limited and have not kept pace with the sheer explosion of the number of digital files that users have today. Digital file data is increasing day by day and further every year there is some new digital file format invented around the world. Further, the present advancement in the computing technology domain has tremendously increased the number of digital file over various data repositories and data storage clients. Whenever, a user searches for a specific digital file then the said conventional digital file searching interface presents a number of digitals files. Most of the time, such presentation is based on the keyword entered by the user over the searching interface.

Accordingly, the task of searching and locating a specific digital file via the conventional digital file searching interfaces are usually time consuming and tedious. Further, the conventional digital file searching interfaces require the user to spend a lot of time for identifying the relevant digital file from the search results. This consumes extra processing time and hence is undesirable. This problem needs to be technically solved. Further, these conventional digital file searching interfaces require the user to scroll and go through a series of digital files displayed in the search results to identify the relevant digital file that the user is searching for.

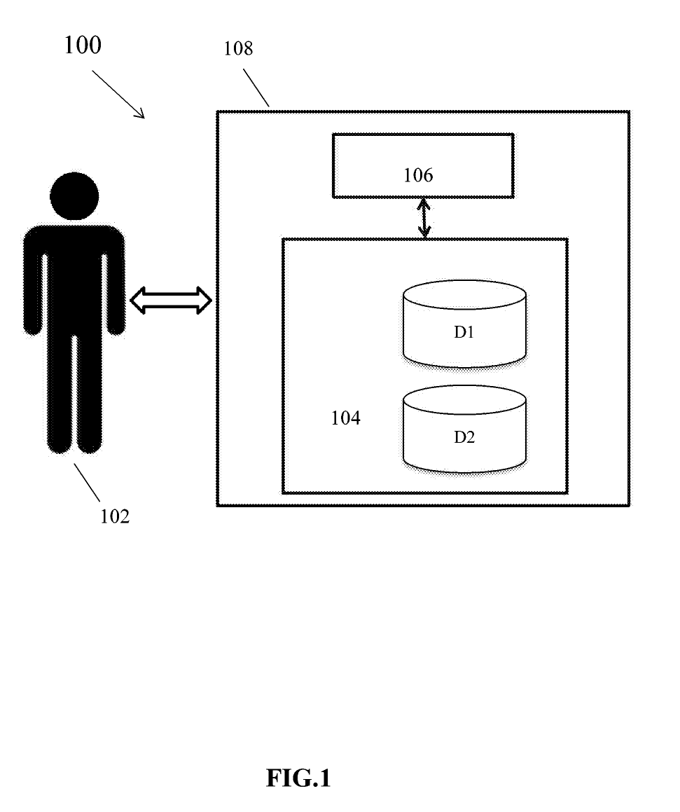

The method and system as disclosed herein performs searching and ranking of digital files with the help of a processor or computer assisted platform such as a plug-in, an add-on program, a software, an application on mobile phone/tablet/PDA or other similar platform. Wherein, such computer assisted platform is connected with the data repositories. Hereinafter, the term “computing device” is referred to such above mentioned computer assisted platform which is connected with data repository. The searching and ranking of digital files is based on one or more pre-defined context and algorithm. The systems and methods will now be explained in conjunction with FIGS. 1-4 as below.

In an embodiment of the present invention, the computer implemented method is capable of running independently as well as a plug-in integrated in a data repository to search and rank a plurality of attachments. In other words, the present method may be implemented as a standalone application or as plug-in integrated in/or connected to a data repository. The plurality of attachments comprises at least a digital file present in at least one data repository.

Now referring to FIG. 1 illustrating a block diagram of a system 100 which shows the environment in which the present invention is implemented. FIG. 1 includes a user 102 and a computing device 108 such as a PDA (personal digital assistant), a desktop, a laptop, a mobile phone, a smartphone, a tablet, a processor based wearable device, a communication device and the like.

The computing device 108 also includes a search interface 106 and a data repositories 104 on which searching and ranking of digital files has to be performed. As mentioned above, the searching and ranking of digital files is also conductible on the online data repositories 104, in one implementation of the present invention. In another embodiment of the present invention, the searching and ranking of digital files is also conductible on data repositories 104 as present on the remote servers.

In an embodiment of the present invention, the search interface 106 is triggered by an audio like saying “search file”, or by a certain gesture like “tapping the screen of a computing device” or “waving” or “air gesture”, or by press of a button etc.

Furthermore, as shown in FIG. 1, the search interface 106 is a plug-in or other similar search platform which is connected to the data repositories 104. The search interface 106 is adapted to perform the facility of searching and ranking of digital files in the data repositories 104.

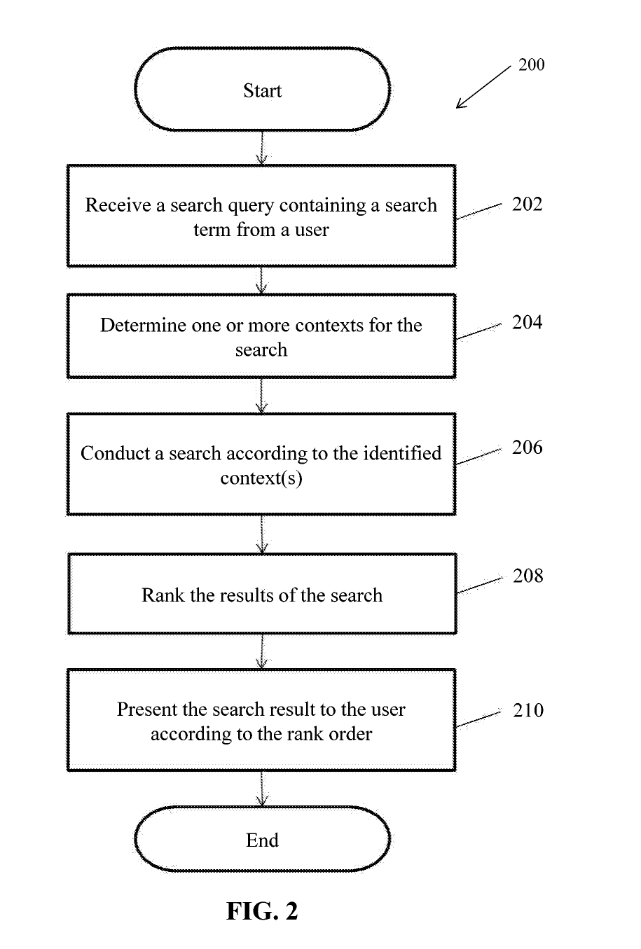

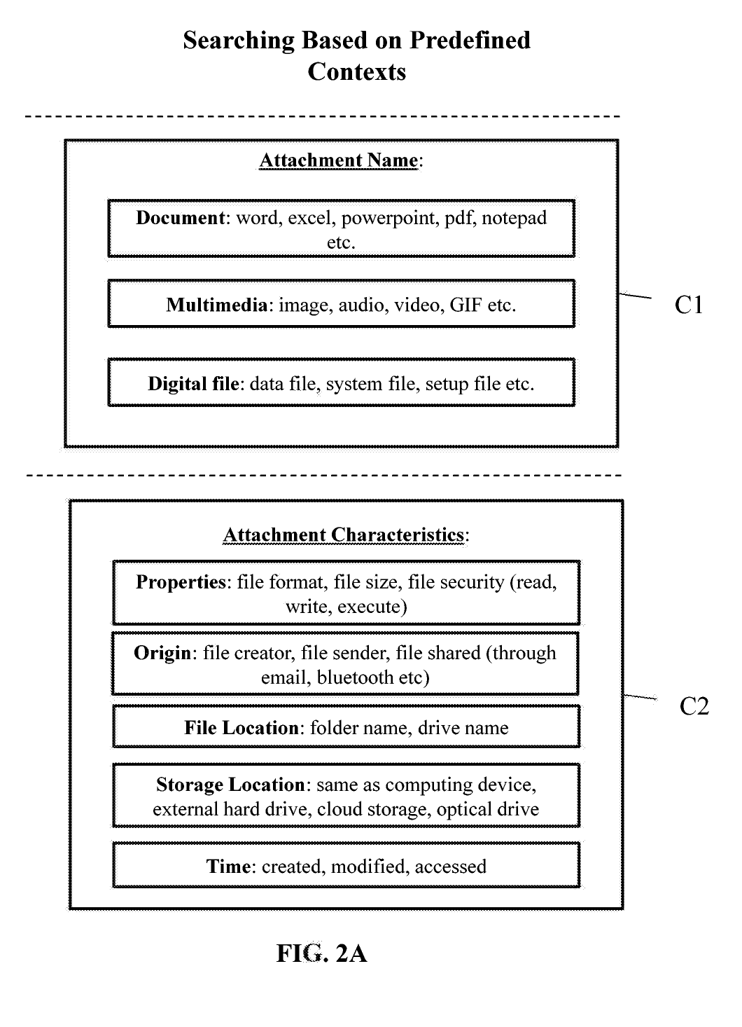

Now referring to FIG. 2, a method 200 has been shown for searching and ranking of documents, attachments or digital files, as per various embodiments of the present invention. The method includes the following steps to fulfill the objective of the invention. The method starts at step 202, where the computing device 108 receives a search query containing at least one search term from a user. Such search query is entered by the user using the search interface 106. The at least one search term as provided herein is selected from at least a text, a numeral, a word, an alphabet, a special character, a text, a sign, an alphanumeric, an image, a video, an audio input, a graphics interchange format (GIF), a word, braille characters and/or a combination thereof.

The search query further includes at least one search term which is directed to retrieve one or more digital files from the data repository 104. Suitable examples of the search query include search queries in form of a string composed of one or more words, like “patent image file”, or a term like “patent.doc.” It should be understood that these examples are non-limiting and should not be construed as limiting the present invention.

Accordingly, as per one embodiment of the present invention, when user 102 wishes to search for a particular keyword(s) or a particular search term(s), then the user inputs such search term(s) in the search box of the search interface 106.

As per one embodiment, the input can be in the form of one or more keywords or a string of words or search terms. In addition to providing one or more search terms, the user may choose to select one of the advanced search options given in the drop-down menu provided by plug-in or other similar platform 106. For example, the user can input “patent” as a search term and choose the extension “.jpg” from the options he is presented with.

In an exemplary embodiment, if a user types “Ross presentation patent jan”, the method 200 instead of treating the search query as normal search query automatically and without the use of menus or the without user having to specify anything, treats it under advanced search option and identifies that user is trying to find a file created by or sent by or sent to “Ross”, either titling or containing text “patent” which has “.ppt” format and was created/sent in the month of “January”. This example is mere one way among multiple ways using which the present method 200 runs a search on the computing device 108 having data repository 104. The above example is an implementation which illustrates that the method 200 assumes the search to be advanced search even when the user doesn't choose so.

In an exemplary embodiment, when the user inputs search term as “from: John to: Clarke”, the method 200 presents search results with 5 files. The files are presented on the basis of ranking criteria. The method ranks a file at 1^{st} position because the said file has been sent from “John” and received by “Clarke” after modifications. Further, the file presented at the top was a “Letter (Application)”, a word file and had text that said “To, [symbol] Clarke”. The second file presented is a pdf file that is modified recently and had maximum number of modifications. The third file presented was a file that was sent from “John” to “Clarke” where the user is in “cc”, however, this file is over a month old. The fourth file presented was identified at both the folders on the hard drive of the user. The said folders were named after “John” and/or “Clarke”. The last file i.e. 5^{th}, presented to user had text “John” as well as “Clarke” marked in bold, italics and as heading in the said file.

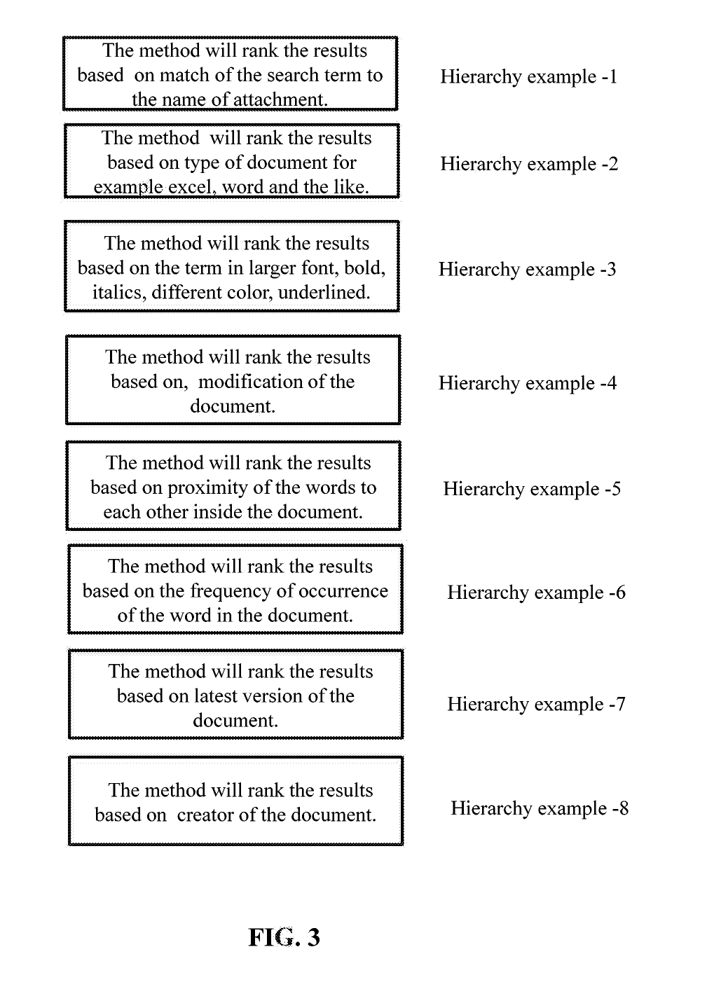

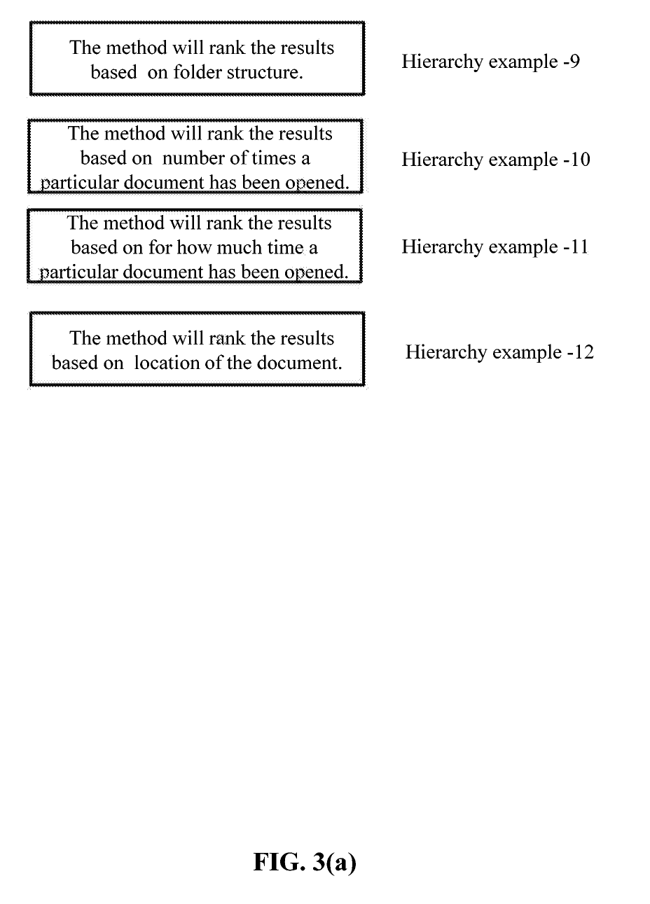

The above example shows a way of how efficiently the present method for searching and ranking a plurality of attachments in a computing device works. However, there are several other criteria to search and/or rank the files and hence the above example is mere illustration that should be not be construed as a limitation of the present invention. The other ways of ranking the attachments have been discussed in the description of FIG. 3.

Further, the method flows to step 204. At step 204, the method identifies one or more contexts for the search term. Various contexts are as shown in FIG. 2A. Further, at step 206, the method conducts a search according to the identified context(s) in step 204.

In one embodiment, the identification of the context is as per the U.S. granted Pat. No. 8,745,045 by the inventors of the present patent application. In another embodiment, the identification of the context of the search term may be as per the known in the art techniques. In this case, the context may be directly related to the literal meaning of the search term. For example, the search term being “word doc” refers to the context being a file that is a word document. In an exemplary embodiment where context is a literal meaning, if such a search term is identified then highest priority is given to the MS Word documents. There are several other criteria for identifying the context of a search term, disclosed herein-below.

The context of a search term includes literal meaning of the search term, attachment name, attachment type, attachment size, sender/author and/or recipient, font characteristics of attachment and the like.

In one embodiment, as per the example illustrated above, in case the user inputs “patent.jpg” as a search term, at step 204, the method determines at least one context of the search using the received user input/search term. In such a case, the plug-in or other similar platform 106 determines the context out of a plurality of pre-defined contexts. For example, for search input “patent.jpg”, or “patent jpg” it is determined that the user is probably looking for a digital file that has the term “patent” in the file name with “.jpg” in its file type.

Among the above mentioned case, several other permutations are run to identify the search term. Like for the above search term “patent jpg” the method 200 assumes the user is looking for a document that contains the word “patent” and has pictures (images) embedded therein.

Once the search is conducted at step 206, the method moves to step 208, where the method is adapted to rank the search results or digital files, the ranking is done as per predefined hierarchy criteria. At step 208, the method sorts the searched digital files based on the degree of ranking associated with each of such digital files. Finally, at step 210, the method displays/presents the digital files to the user 102 according to a predefined rank order and then the method terminates.

The method of ranking the search results or the digital files will now be explained in detail with reference to FIGS. 3 and 3(a).

FIGS. 3 and 3(a) illustrate exemplary hierarchy patterns which are followed to rank the results or the digitals files and to present such ranked results to the user.

In an embodiment, as shown in hierarchy example-1, the ranking is done based on a match of the search term to the name of digital file. For example, as per one embodiment of the present invention, digital file names which exactly/perfectly match with the users search query will be given the highest ranking, followed by those digital files which partially match with the search query from left to right, then from right to left, followed by those digital files where at least some of the characters of the search term are part of the digital file name.

In various embodiments of the present invention, the results are presented to the user based on the general information related to the search term, synonyms/antonyms of the search term, direct matching of the search term, matching left to right or right to left, then matching only few letters of the search term, etc. For example, if the user searches for “The Last Testament”, then the present method of searching and ranking presents attachments as files with name “last testament”, “The Final Testament of The Holy Bible”, files with name “Holy Bible”, images with name as “last testament”, audio(s)/video(s) with file name as “last testament”, audio(s)/video(s) by the famous author(s)/people like “The Last Testament (Book by Jonathan Freedland)” or “The Last Testament: A Memoir by God by David Javerbaum” or “The Last Testament by Sam Bourne” etc.

In an aspect, the ranking is done by giving certain file types more importance than others. For example, files types word and pdf may be given a higher weightage than file type xls.

In another exemplary embodiment, if the user inputs a search term “Ramayan”, then the results based on file name would include files with names “Ramayana”, “Ram”, “Sri Ram Charit Manas” etc. The system will first look for a perfect match, then a match from left to right, then match where maximum number of words of the input and the output match, which will keep reducing like x=total number of words inputted and y=total number of words in the output. Here the system will first look for a situation in which x=y, then x=y−1 and so on. Alternatively, it checks where x=y, then x=y+1, then x=y+2 and so on.

In an implementation, if the search term is “cooperation” then the results are with file name first which match perfectly like “cooperation” will be shown first, then words which match from left to right like “co-operate”, or “collaborate”, or “team”, or “corporate”, or “cooperation” etc.

In an embodiment of the present invention, the attachments' names are matched exactly with the search terms, or the attachments are matched with or without special characters, spelling errors, synonyms/antonyms, or the attachments are matched “left to right” or “right to left” with search term, etc. These are few ways among many that the present invention uses to rank attachments. For example, if the user searches for “architecture”, the present method ranks and provides the results first on exact match for search term, then results based on spelling errors, synonyms, antonyms, special characters, etc. Hence, the results for the said search yields files (in descending order) such as “architecture.pdf”, “archtect.doc”, “arch.ppt”, “RISC Architecture. pdf”, “B.Arch.jpeg”, “construction and design—a documentary”, etc.

In an implementation if the search terms are not contained in the name of the file the following ranking methodology is used in different combinations thereof. This may or may not be used in conjunction with the above. The system will search the names of sheets/pages/chapters/series/volumes within each digital file. For example, a Microsoft™ excel digital file may have various sub-sheets which have individual names and the system displays these as digital files after displaying the digital files stated above.

In another embodiment, the ranking is done based on the type of digital file. For example, as shown in hierarchy example-2, a digital file in MS Word format may be given a higher ranking as compared to digital files of MS Excel file format, and the like. A PowerPoint file may be given a higher ranking over an MS word file and so on. A digital file in pdf format may be given equal ranking as a digital file in Word format. This ranking will be based on various factors including but not limited to the users preferences, the users search history, the number of files in the data repository, the size of the data repository, the number of each type of file (.jpg, .xls, .pdf, etc.), the size of each file, the users location, etc.

According to an embodiment of the present invention, the ranking is done based on user search history. For example, the present method keeps track of the particular attachment opened corresponding to a search performed. Say, a user selects a word file with file name “Invention” that as size of 800 kB (less than 1 MB) each time he searches for “invention”. This activity or user history is saved by the present system and method and if the user searches for “invention” in future, he is presented with that particular word file with name “Invention” which was selected earlier.

According to hierarchy example-3, the ranking is done based on font characteristic. Say, words in the largest fonts compared to the size of fonts in the rest of the documents, in digital files stored in a repository, bold fonts, italic fonts, and fonts of different colors, underlined fonts, certain font sizes, and certain font types may be ranked higher as compared to other fonts. And these files may be ranked higher based on the font weightage compared to other files containing text in normal fonts.

In an implementation, words which form part of the headings of inline tables are given higher ranking. Also words/phrases/sentences which form part of bullet points or words/phrases/sentences that are numbered might be given higher ranking. Further words, phrases that are titles and/or sub titles might be given higher ranking.

According to hierarchy example-4, the ranking is based on digital file modification and formation. For example, as per one embodiment of the present invention, the digital file which has been most recently modified, created, accessed, downloaded or added is allotted higher ranking compared to others. Also, the ranking is done based on the latest version of the file. For example, if there are files named “Patent application 1”, “Patent application revised 2”, “Patent application revised my comments 3”, or “Patent application 28^{th} September”, the files are of the same format type and have dates close to each other, are similar in size, then the method ascertains that the files are modifications of each other. The method then shows the file which has been modified the last or which has a higher numeral in the file name.

In an exemplary embodiment of the present invention, the ranking is based on number of authors. Say, a document has been written by, commented on, or reviewed by 10 users; it will be ranked higher compared to ones written by, commented on, or reviewed by less than 10 users.

In another embodiment, the ranking is based on modifications of files or documents. Say, a word file has been modified 10 times then it will be ranked higher to other word files that have been modified less than 10 times. In an implementation, a file is ranked higher if it is been authored by and modified by more users.

In an embodiment, in case more than one word is input as the search term, the ranking is done based on proximity of the words to each other inside the digital file. As per hierarchy example-5, a digital file containing the search term four times and that too contiguous to each other, is shown higher in results as compared to a digital file containing the search term four times but in a format where the words are non-contiguous.

In another embodiment for ranking the digital files, as per hierarchy Example-6, the ranking is done based on the frequency of occurrence of the search term in the digital file. For example, a digital file containing the search term five times is shown higher in hierarchy as compared to the digital file containing the search term three times.

In an exemplary embodiment of the present invention, the results are ranked based on identifying the search input in different sections of the files. Say, a search term input is “energy” then the file with most occurrences of the word “energy” is ranked higher. In an implementation, the file with most occurrences of word “energy” in headings, sub-headings etc. are ranked higher.

In yet another embodiment of the present invention, the digital files which are created in the same versions of office suite or office productivity which the user has is ranked higher. For instance, according to hierarchy example-7, a word document created in office 2013 is ranked higher in case the user also has Office 2013 than a document created in office 2010.

In another embodiment, ranking is done by giving greater weightage to recent files opened or created by the user in applications like Word and Excel, over other files.

In yet another embodiment of the present invention, ranking of multiple files is done based on whether the files were part of one email which had the files or multiple emails. The system groups documents which were part of one email together and which have then been modified.

According to hierarchy example-8, digital files created by the user of the computing device are ranked higher than those created by others. Like a file created by the user will be ranked higher in comparison to the file received or downloaded from internet.

In another exemplary implementation, the ranking is done based on the designation of the user. Say, a user searches for an email attachment, the attachment corresponding to a mail sent to or sent by Manager is ranked higher to the ones sent to or sent by Associates when the search results are displayed. In yet another implementation, the search results are ranked based on the department assigned to users. Say, the attachments of email clients where the sender/receiver belong to HR department are ranked higher than the ones sent to or received by Admin department.

In yet another embodiment, the attachments are ranked on the basis of company/organization. Say, the user has a couple files with same name but authored by different companies, “Tesla” and “Google”. When the user searches for “electric car document”, the file authored by “Tesla” is ranked higher than the file authored by “Google”.

In yet another embodiment, as per hierarchy example-9, digital files which are higher in a folder tree, like the first sub folder or the root folder, may be given higher ranking than a digital file which is lower in the folder tree.

In an embodiment of the present invention, the results are ranked based on the location of the file. Say, a user searches for “invent”, the user is presented with results in the following order, “inventions.pdf”, “inventor.xls”, and so on. Now, the presentation of the results in such order is based on the location of the files. The file “inventions.pdf” is present in “D:\documents\patent” while another file “inventor.xls” is present at the desktop, the file “inventions.pdf” is ranked higher considering the user already knows about file present on desktop and is not looking for the same. The user in this case wants to access the file in the “D” drive but is unable to do so since it is not readily available unlike the file present on desktop. In another embodiment, the file present on desktop is ranked higher than the file present in the “D” drive.

Hierarchy example-10 ranks the digital files which have been opened the maximum number of times higher than those that have never been opened or opened a less number of times.

In another embodiment as per hierarchy example-11, ranking is done based on the duration of time during which the digital file was open on the user's computer. It is surmised that digital files which have been opened for a longer duration of time, may be of more interest to the user, as the user may have modified, created or read the digital file with greater interest. The system also takes into account ‘time outs’ like when the system is in idle mode to calculate the same.

In another embodiment as per hierarchy example-12, the ranking is done based on whether the digital file is located locally on the user's computing device. If the digital file is located locally on the users' computing device then such digital file is given higher ranking as compared to the digital files present on the remote servers.

In an embodiment, only the section of the file which cites the search term is displayed while the results are shown. This helps the user to quickly scan through the search results without actually opening the file.

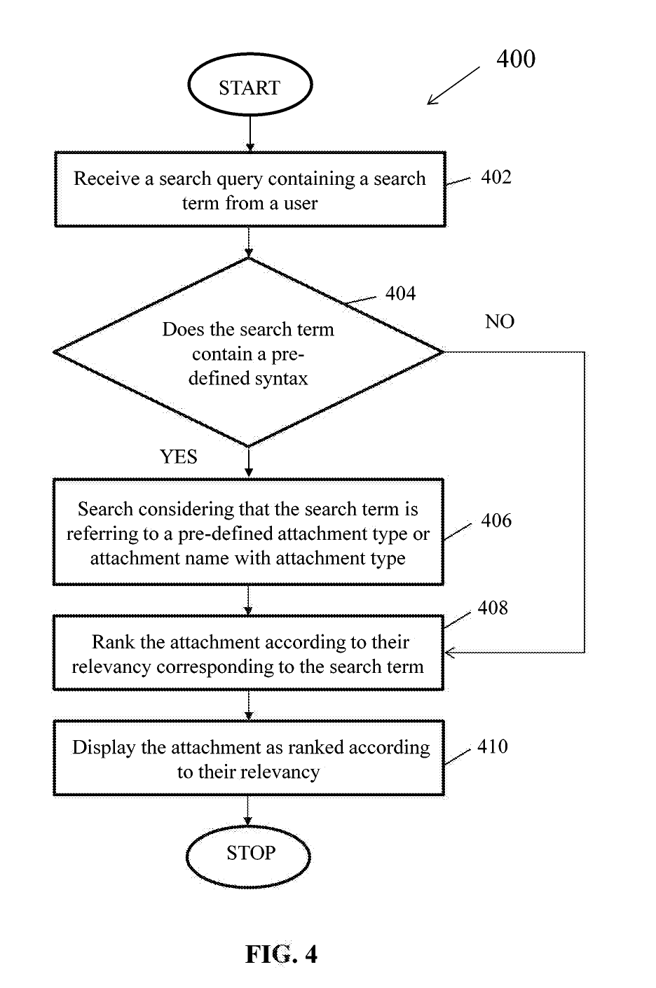

Now referring to FIG. 4, a method 400 has been shown which illustrates how a relevant digital file is provided to the user. The method 400 starts at step 402 where a search box is provided on the user interface, here the user enters the search term. As per various embodiments, the search term could be one or more words signifying digital file type, format, or may be a pre-defined syntax as per user's understanding and need(s). Thereafter, the method flows to step 404.

At step 404, the method 400 decides whether the user's search term contains a pre-defined syntax. The method decides this by performing a check on the user input. The method first checks if the user's input refers to a digital file name with digital file type, for example “book. doc” or “book doc” and the like. The method then checks if the user input refers to digital file type only, for example “.doc”. If the result is “YES”, then method 400 moves to step 406. At step 406, the method searches for the digital files matching the intelligent check performed at step 404.

Then at step 408, the method 400 ranks the digital files according to their relevancy corresponding to the search term, as per the various hierarchy criteria as described with reference to FIG. 3 and FIG. 3(a). Finally at step 410, the method 400 displays the digital files sorted at step 408.

In another exemplary embodiment, the present system and method is adapted to automatically create folders by grouping plurality of attachments or all the search results/files. In such a grouping, the user can check a grouping option which automatically extracts all the search results/files either in one folder or more than one folder and present such files to the user as per the ranking given to such files.

If the search input does not contain a pre-defined syntax, then method 400 moves directly to step 408 and the digital files are displayed based on degree of ranking at step 410. Thereafter the method terminates.

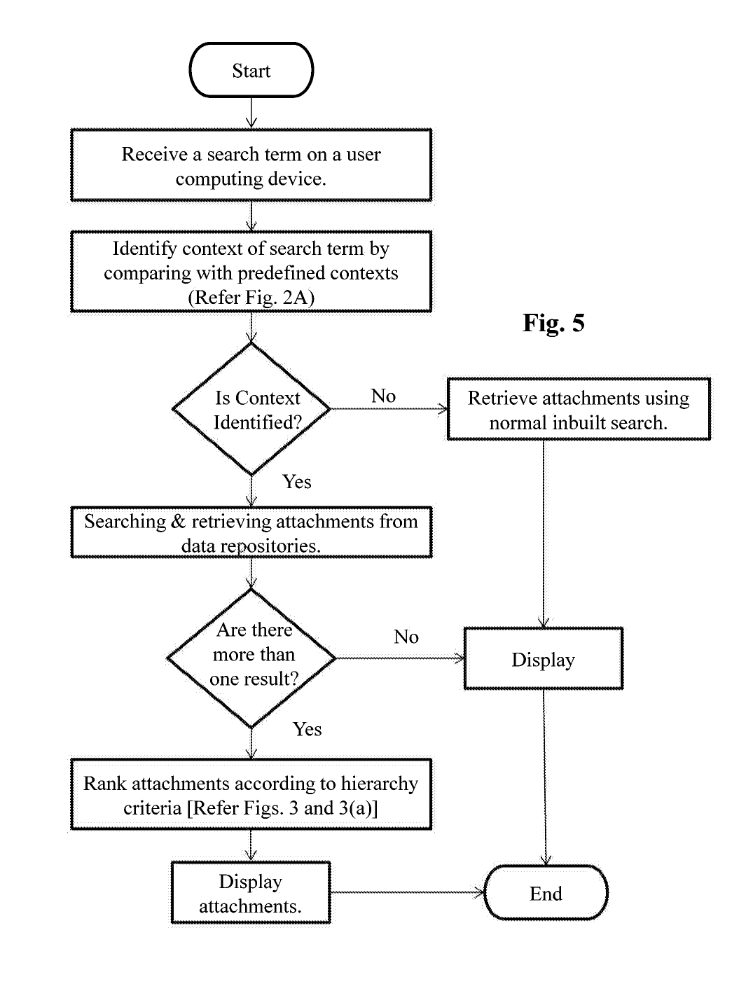

Further, FIG. 5 illustrates end to end flow chart of the process of the present disclosure, in accordance with various embodiments as described hereinabove.

In an embodiment of the present invention, the present computer implemented method for searching and ranking a plurality of attachments, also takes in consideration the location of the user, time and date of the search, temperature and/or environment conditions of the location of the user, general information from internet etc. while searching and ranking the attachments.

In an aspect, if the user is visiting his hometown (a place different than his residence) during Christmas and he searches for “holiday image”, then he would be presented with images of last Christmas he spent at his hometown. This shows that the present invention also searches and ranks attachments based on location of user and time.

In another aspect, when the user opts to search for a particular attachment, he is presented with suggestive results without even inputting a search term.

For example, the present invention keeps track of the user history and its pattern with time of the day. The present method of searching and ranking remembers that user has a tendency to read an eBook named “The Alchemist” authored by “Paulo Coelho” in the night after 10 pm. Whenever, the user at 10:15 pm opts to search using the interface provided by present invention in his computing device, then he is automatically presented with the said eBook as a suggestion. Further, the e-book when selected by the user as the suggestion is opened at the page where the user was last reading.

The computer implemented methods for searching and ranking as disclosed in the present invention provides faster computation time, reduces the processing burden on processing elements of a computer, and increases the quality of the digital files retrieved from various data repositories. The disclosed searching algorithms which are based on identification of context of the inputted search term and the subsequent ranking algorithm eases the computing load on a computer processor and significantly increases the relevance of the digital files retrieved via a search interface running on a computing system.

It should be noted that the exemplary embodiments pertaining to ranking as described in the preceding paragraphs should not be construed as a limitation to the present invention. Accordingly, many variations of these embodiments are envisaged within the scope of the present invention.

The present invention should not be construed to be limited to the configuration of the method and system as described herein only. Various configurations of the system are possible which shall also lie within the scope of the present invention.

The method, as described in the disclosed teachings or any of its components, may be embodied in the form of a computer method. Typical examples of a computer method include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

In a computer method comprising a general purpose computer, such may include an input device, and a display unit. Specifically, the computer may comprise a microprocessor, where the microprocessor is connected to a communication bus. The computer may also include a memory the memory may include Random Access Memory (RAM) and Read Only Memory (ROM). The computer method further comprises a storage device it can be a hard disk drive or a removable storage drive such as a floppy disk drive, optical disk drive, and the like. The storage device can also comprise other, similar means for loading computer programs or other instructions into the computer method.

The computer method may comprise a communication device to communicate with a remote computer through a network. The communication device can be a wireless communication port, a data cable connecting the computer method with the network, and the like. The network can be a Local Area Network (LAN) or a Wide Area Network (WAN) such as the Internet and the like. The remote computer that is connected to the network can be a general-purpose computer, a server, a PDA, and the like. Further, the computer method can access information from the remote computer through the network.

The set of instructions may include various commands that instruct the processing machine to perform specific tasks such as the steps that constitute the method of the disclosed teachings. The set of instructions may be in the form of a software program. The software may be in various forms such as method software or application software. Further, the software might be in the form of a collection of separate programs, a program module with a larger program or a portion of a program module. The software might also include modular programming in the form of object-oriented programming. The software program or programs may be provided as a computer program product, such as in the form of a computer readable medium with the program or programs containing the set of instructions embodied therein. The processing of input data by the processing machine may be in response to user commands or in response to the results of previous processing or in response to a request made by another processing machine.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A computer implemented method for searching and ranking a plurality of attachments in a user computing device, wherein the computer implemented method comprising:
receiving at least one search term from a user over the user computing device;
identifying a search context, wherein the search context is based on the at least one received search term;
searching at least one received search term in at least one data repository connected to the user computing device and retrieving the plurality of attachments, wherein the said retrieving is based on the search context;
ranking the said retrieved plurality of attachments, wherein the said ranking is based on a plurality of pre-defined hierarchy criteria;
sorting the said ranked plurality of attachments, wherein the sorting is based on a degree of ranking of each attachment of the retrieved plurality of attachments; and
displaying the said sorted plurality of attachments through the user computing device.

2. The computer implemented method as claimed in claim 1, wherein the at least one data repository is selected from the group consisting of a plurality of online data repositories and a plurality of offline data repositories.

3. The computer implemented method as claimed in claim 1, wherein the user computing device comprises at least a processor, at least a user interface, at least a network connection, and at least one data repository.

4. The computer implemented method as claimed in claim 1, wherein the search context comprises at least one of the search term, a pre-defined syntax, and a combination thereof.

5. The computer implemented method as claimed in claim 1, wherein the pre-defined syntax is selected from various types of file formats.

6. The computer implemented method as claimed in claim 1, wherein the pre-defined hierarchy criteria is based on matching of search term to at least one of the name of the attachment, type of attachment, font characteristic of the attachment.

7. The computer implemented method as claimed in claim 1, wherein the pre-defined hierarchy criteria is based on characteristics of search terms in the attachment.

8. The computer implemented method as claimed in claim 7, wherein the characteristics of search terms comprises proximity of the words of the search term inside the attachment, frequency of occurrence of the search term in the attachment, date of attachment formation, date of modification, creator of the attachment, number of times the attachment has been opened, time duration for which a particular digital attachment has been opened, and location of the digital file.

9. The computer implemented method as claimed in claim 1, wherein the pre-defined hierarchy criteria is based on location of an attachment, wherein the attachment located locally on the user's computing device is ranked higher.

10. The computer implemented method as claimed in claim 9, wherein the location of the attachment is further based on a folder tree of a computing device and wherein the attachment of first sub-folder of the folder tree is ranked higher.

11. The computer implemented method as claimed in claim 1, wherein the degree of ranking is based on the number of pre-defined hierarchy criteria met for each of the said retrieved plurality of attachments.

12. The computer implemented method as claimed in claim 1, wherein displaying the said sorted plurality of attachments is based on the higher degree of ranking to lower degree of ranking.

13. The computer implemented method as claimed in claim 1, wherein displaying the said sorted plurality of attachments is based on grouping the plurality of attachments in at least one folder.
